(19) United States
(12) Patent Application Publication
(10) Pub. No.: US 2019/0090044 A1
(43) Pub. Date: Mar. 21, 2019

(54) Earpiece with user adjustable white noise

(71) Applicant: BRAGI GmbH, München (DE)

(72) Inventor: Peter Vincent Boesen, München (DE)

(73) Assignee: BRAGI GmbH, München (DE)

(21) Appl. No.: 16/122,077

(22) Filed: Sep. 5, 2018

Related U.S. Application Data
(60) Provisional application No. 62/560,819, filed on Sep. 20, 2017.

(51) Int. Cl. H04R 1/10; H04R 1/08; G10K 11/178

(52) U.S. Cl. CPC H04R 1/1016; H04R 1/08; G10K 11/1785; H04R 2460/13; H04R 2430/01; H04R 2420/07; H04R 2460/01

(57) ABSTRACT

A wireless earpiece in embodiments of the present invention may have one or more of the following features: (a) an earpiece housing, (b) a processor disposed within the earpiece housing, wherein the processor is configured to generate white noise, (c) a speaker for transducing the white noise operatively connected to the processor, (d) a user interface for operatively selecting the white noise operatively connected to the processor, wherein the wireless earpiece is configured to communicate the white noise at the speaker at a volume level set by a user through the user interface, (e) a wireless transceiver disposed within the housing and operatively connected to the processor, wherein the wireless transceiver communicates the white noise to a second earpiece associated with the wireless earpiece, and (f) a memory operatively connected to the processor, wherein a hearing test is stored in the memory.

### PRIORITY STATEMENT

This application claims priority to U.S. Provisional Patent Application No. 62/560,819 filed on Sep. 20, 2017 titled Earpiece with User Adjustable White Noise all of which is hereby incorporated by reference in its entirety.

### FIELD OF THE INVENTION

The illustrative embodiments relate to wearable devices. Particularly the illustrative embodiments relate to wireless earpieces. More particularly, but not exclusively, the illustrative embodiments relate to wireless earpieces.

### BACKGROUND

Sound conditioners camouflage undesirable noise in the environment by generating white noise or background sounds such as the sound of ocean surf, rain, a rain forest, or a heartbeat. These devices are stand-alone units and usually sit on a night stand or the like for use by individuals at night to aid sleep.

Other mechanisms for avoiding exposure to unwanted sounds include passive mechanisms such as ear plugs or ear covers with noise-absorbing qualities. Active noise cancellation techniques are also known and involve the use of a microphone for receiving external sounds which are converted into an electrical signal, after which an opposing-phase signal is generated. This opposing-phase signal is then supplied to a speaker in a headset and serves to cancel at least some of the external sounds by destructive interference.

In various situations a person may be more comfortable when listening to white noise. For example, for sufferers of tinnitus, white noise may help mask the ringing in their ears, leading to a better quality of life. White noise may also be used for relaxation or to neutralize background noise which may be distracting or annoying. Available devices make it difficult to experience white noise in various environments.

### SUMMARY

Therefore, it is a primary object, feature, or advantage of the illustrative embodiments to improve over the state of the art.

A wireless earpiece in embodiments of the present invention may have one or more of the following features: (a) an earpiece housing, (b) a processor disposed within the earpiece housing, wherein the processor is configured to generate white noise, (c) a speaker for transducing the white noise operatively connected to the processor, (d) a user interface for operatively selecting the white noise operatively connected to the processor, wherein the wireless earpiece is configured to communicate the white noise at the speaker at a volume level set by a user through the user interface, (e) a wireless transceiver disposed within the housing and operatively connected to the processor, wherein the wireless transceiver communicates the white noise to a second earpiece associated with the wireless earpiece, and (f) a memory operatively connected to the processor, wherein a hearing test is stored in the memory.

A method for providing white noise using a wireless earpiece in embodiments of the present invention may have one or more of the following steps: (a) receiving a command to generate a white noise signal at a user interface located on the wireless earpiece, (b) generating a white noise for a user, wherein a processor operably connected to the user interface and disposed within the wireless earpiece generates the white noise, (c) communicating the white noise to the user utilizing a speaker operatively connected to the processor of the wireless earpiece, (d) transmitting, via a wireless transceiver operatively connected to the processor, a signal associated with the white noise to a second wireless earpiece associated with the wireless earpiece, (e) performing a hearing test in response to a request from a user for automatically selecting the white noise based on results of the hearing test, and (f) receiving sound at a bone conduction microphone positioned proximate to a tympanic membrane within an ear canal of the user, wherein the white noise is generated in response to the sound received by the bone conduction microphone.

A system for generating white noise in embodiments of the present invention may have one or more of the following features: (a) an earpiece housing, (i) a processor disposed within the earpiece housing, wherein the processor is configured to generate white noise, (ii) a speaker for transducing the white noise operatively connected to the processor, (iii) a transceiver for sending and receiving communications, and (iv) a user interface for operatively selecting the white noise operatively connected to the processor, (b) a mobile device, (i) a transceiver for sending and receiving communications, (ii) an application for controlling the set of wireless earpieces, wherein the application of the mobile device can instruct the processor of the set of wireless earpieces to generate white noise for transducing the white noise to a user at the speaker, and (c) an internal air microphone operatively connected to the processor and positioned proximate to a tympanic membrane of the user, and wherein the internal air microphone is configured to receive an ear canal sound in response to the test pulse communicated by the speaker.

One or more of these and/or other objects, features, or advantages of the illustrative embodiments will become apparent from the specification and following claims. No single embodiment need provide every object, feature, or advantage. Different embodiments may have different objects, features, or advantages. Therefore, the illustrative embodiments are not to be limited to or by an object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 illustrates a block diagram of a wireless earpiece in an embodiment of the present invention;

FIG. 2 illustrates a block diagram of a second embodiment of the wireless earpiece in an embodiment of the present invention;

FIG. 3 illustrates a mobile device in operative communication with a set of wireless earpieces in an embodiment of the present invention;

FIG. 4 shows a right wireless earpiece and its relationship to a user's external auditory canal and tympanic membrane in an embodiment of the present invention;

FIG. 5 illustrates a flowchart of a method of providing white noise using a wireless earpiece in an embodiment of the present invention;

FIG. 6 illustrates a flowchart of a method of providing colored noise using a wireless earpiece in an embodiment of the present invention; and

FIG. 7 illustrates a flowchart of a method of providing colored noise in response to a hearing test using the wireless earpiece in an embodiment of the present invention.

Some of the figures include graphical and ornamental elements. It is to be understood the illustrative embodiments contemplate all permutations and combinations of the various graphical elements set forth in the figures thereof.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of user-adjusted white noise for wireless earpieces, it is fully contemplated embodiments of the present invention could be used in most any sound reproduction device without departing from the spirit of the invention.

It is an object, feature, or advantage of the illustrative embodiments to provide an earpiece which allows a person to listen to white noise.

It is a further object, feature, or advantage of the illustrative embodiments to provide tinnitus masking as a set or individually.

It is a still further object, feature, or advantage of the illustrative embodiments to allow a user to adjust the volume of white noise to a level which they are comfortable.

In one embodiment, a wireless earpiece includes an earpiece housing, a processor disposed within the earpiece housing, wherein the processor is configured to generate white noise, a speaker operatively connected to the processor and a user interface operatively connected to the processor. The wireless earpiece is configured to transduce the white noise at the speaker at a volume level set by a user through the user interface.

One or more of the following features may be included. A wireless transceiver may be disposed within the housing and operatively connected to the processor for communicating the white noise to a second earpiece. A memory may be operatively connected to the processor, wherein a hearing test is stored on the memory. The user interface may provide for haptic control. The user interface may provide for voice control. The hearing test stored on the memory may be selectable using the user interface. The speaker may communicate a test pulse in accordance with the hearing test. An internal air microphone may be operatively connected to the processor and may be positioned proximate to a tympanic membrane of the user. The internal air microphone may be configured to receive an ear canal sound in response to the test pulse communicated by the speaker. A bone conduction microphone may be operatively connected to the processor and may be positioned proximate to a tympanic membrane of the user. The bone conduction microphone may be configured to receive an ear canal sound in response to the test pulse communicated by the speaker. The processor may generate the white noise in response to the ear canal sound received by the internal air microphone. The processor may generate the white noise in response to the ear canal sound received by the bone conduction microphone. The white noise may be adjusted by the processor in accordance with readings from a sensor.

In another embodiment, a method for providing white noise using a wireless earpiece includes generating, via a processor, a signal encoding the white noise and transducing, via a speaker operatively connected to the processor, the signal encoding the white noise.

One or more of the following features may be included. A wireless transceiver operatively connected to the processor may transmit the signal encoding the white noise to an electronic device. The electronic device may be a second wireless earpiece. The speaker may provide a hearing test in response to a request from a user at a user interface, wherein the user interface may be operatively connected to the processor. Sound may be received at a bone conduction microphone positioned proximate to a tympanic membrane within an ear canal of the user. The signal encoding the white noise may be modified in response to results provided by the user in response to the hearing test. The signal encoding the white noise may be modified in response to the sound received by the bone conduction microphone. A volume of the white noise may be modified in response to a request from a user at a user interface, wherein the user interface is operatively connected to the processor.

The illustrative embodiments provide for a system, method, and wireless earpiece for generating colored noise. White noise is one example of colored noise utilized by the wireless earpieces. The white noise may be utilized for entertainment, focus, convenience or medical treatments. For example, white noise may be used in clinical applications such as tinnitus therapy and attention deficit hyperactivity disorder (ADHD) treatment, acoustic and electronic calibration, computing, and other applications. Colored noise represents various categories of acoustical variables representing ranges of spectral density including, but not limited to, white noise, pink noise, red/brown (e.g., Brownian), purple/violet noise, blue/azure noise, gray noise, or so forth as are known in the art. The colored noise may also include alternatives, such as speech noise, high-tone noise, ambient noises (e.g., ocean, forest, rain, stream, wind, wave noises, etc.), and so forth. The illustrative embodiments may be utilized to perform tinnitus masking.

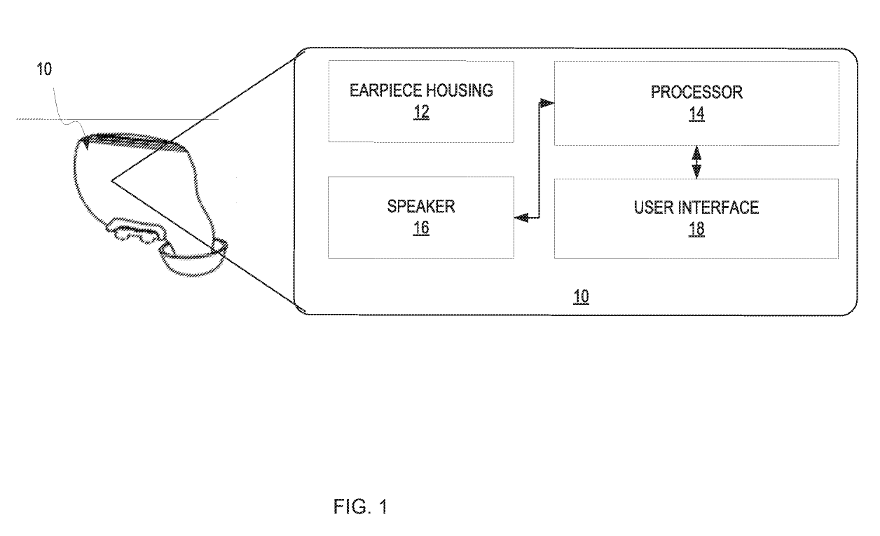

FIG. 1 illustrates a block diagram of a wireless earpiece 10 in accordance with an illustrative embodiment. In one embodiment, the wireless earpiece 10 includes an earpiece housing 12, a processor 14 disposed within the earpiece housing 12 and configured to generate white noise, a speaker 16 operatively connected to the processor 14, and a user interface 18 operatively connected to the processor 14. One or more sleeves may be provided with the wireless earpiece 10 and fitted over a portion of the earpiece housing 12. The sleeves may come in various shapes and sizes and may be used to improve the fit of the wireless earpiece 10 within an ear of a user, improve audio transparency, improve the longevity of the wireless earpiece 10, protect the user from skin allergies, and so forth.

The earpiece housing 12 is a structure shaped to fit substantially within an ear of the user. The earpiece housing 12 may at least partially enclose one or more of the components of the wireless earpiece 10 and may be composed of one or more plastics, one or more metals, one or more polymers, one or more non-metals, or a combination of materials having substantial deformation resistance to facilitate energy transfer if a sudden force is applied to the wireless earpiece 10. For example, if the wireless earpiece 10 is dropped by the user, the earpiece housing 12 may transfer the energy received from the surface impact throughout the entire wireless earpiece 10, minimizing damage. The wireless earpiece 10 may be configured to fit and communicate in the canal (ITC). In some embodiments, the wireless earpiece 10 may utilize different form factors, sizes, and shapes. For example, the wireless earpiece 10 may fit substantially within the ear canal of the user to the point of being almost unnoticeable.

In addition, the earpiece housing 12 may be capable of a degree of flexibility to facilitate energy absorbance if one or more forces is applied to the wireless earpiece 10. For example, if an object is dropped on the wireless earpiece 10, the earpiece housing 12 may bend to absorb the energy from the impact. The flexibility of the earpiece housing 12 should not, however, be flexible to the point where one or more components of the wireless earpiece 10 may become dislodged or otherwise rendered non-functional due to the force of the impact. The earpiece housing 12 may also be waterproof; hermetically enclosing the components within the wireless earpiece 10. A portion of the earpiece housing 12 may also be custom molded, printed, manufactured, or otherwise created to specifically fit the user's ear (e.g., shape, size, etc.).

The processor 14 is disposed within the earpiece housing 12, operatively connected to each of the components of the wireless earpiece 10 and programmed to generate white noise. The processor 14 may be a digital integrated circuit, an analog integrated circuit, a mixed integrated circuit, a field programmable gate array (FPGA), an application-specific integrated circuit (ASIC), a processor unit, a central processing unit (CPU), or another type of component capable of processing data and/or information, and more than one of the types may be integrated together. The processor 14 may include logic circuitry, which may consist of combinational and/or sequential digital logic, for controlling one or more functions of the wireless earpiece 10. The processor 14 may also include a register with data and/or instructions stored thereon for controlling the wireless earpiece 10. In addition, data and/or information stored in one or more cache memories within the processor 14 may be used by the logic circuitry to enhance the functionality of the wireless earpiece 10.

Furthermore, the processor 14 is programmed to execute one or more kernels, applications, programs, commands, and/or instructions to control the wireless earpiece 10 or process data or information received from one or more of the components of the wireless earpiece 10. The kernels, applications, programs, and/or instructions used by the processor 14 may be stored in one or more memories, the register, or one or more of the cache memories within the processor 14. The data and information received from the wireless earpiece components may also be stored in one or more of the memories, the register, or one or more of the cache memories. For example, the processor 14 may execute an application stored in a memory to process a request in the form of a gesture or voice command from the user to access a hearing test for calibrating a volume to best generate the white noise. The processor 14 may use data or information received from an air microphone, a bone conduction microphone, and/or one or more sensors to calibrate the white noise. The processor 14 may also execute one or more kernels while executing the application.

As another example, the processor 14 may execute a program for transmitting a signal encoding the white noise to another electronic device, such as a second wireless earpiece using a wireless transceiver. The signal may encode additional data or information such as the volume, bass, treble, frequency, pattern (if any) or other sound properties of the white noise. Furthermore, the signal may encode other information such as the date and time of transmission, the identity of the user being treated with white noise, a connection frequency or waveform, the device which generated the signal encoding the white noise, or other information which may be of relevance to someone using another electronic device to listen to the white noise. In one example, the signals may be transmitted utilizing Wi-Fi, Bluetooth, NFMI, HD wireless, or other similar wireless standards, protocols, or signals.

The speaker 16 is operatively connected to the processor 14 and may be positioned in an area conducive for communicating sounds, including white noise, to the tympanic membrane of the user's ear. The speaker 16 may include components such as digital-to-analog converters, amplifiers, attenuators, filters, and/or other components necessary for the speaker 16 to convert an electrical signal into a sound wave. Signals encoding white noise generated by the processor 14 may be used for obtaining the impulse response of one or more components of the speaker, which may be used by the processor in modulating additional signals encoding the white noise. In one embodiment, the speaker 16 may include multiple speakers including a tweeter, a mid-range, and a bass speaker or associated component. In another embodiment, the speaker 16 may be configured to generate vibration signals or patterns communicated through the user's ear/head and interpreted by the user's hearing system as white noise.

The speaker 16 may also play music or other types of sounds in response to a command from the user or in accordance with one or more programs or applications executed by the processor 14. The music and sounds may be stored in one or more memories within the wireless earpiece 10 or may originate from an external device, such as a smartphone, laptop, tablet, desktop computer, Wi-Fi hotspot, or another communications device. The music or sounds from the external device may be received by a wireless transceiver operatively connected to the processor 14, which may subsequently instruct the speaker 16 to communicate the music or sounds or store the music or sounds in a memory.

Furthermore, the speaker 16 may communicate a hearing test for ascertaining the user's hearing for calibrating the white noise in accordance with answers or results provided by the user. The hearing tests may include subjective tests such as pure-tone audiometry tests or speech recognition tests and objective tests, such as tympanometric tests and otoacoustic emission tests. Answers provided by the user may be provided verbally, tactilely, through gestures, or with haptics. For example, an air microphone, a bone conduction microphone, or one or more sensors, or other input devices may receive input for completing the hearing test.

The user interface 18 is operatively connected to the processor 14 and may be used by the user to set the volume of the white noise generated by the processor 14. The user interface 18 may include an air microphone for receiving voice commands, a touch interface for receiving touch commands, or a gesture interface for sensing gestures. If the user interface 18 includes an air microphone, the user or a third party may issue voice commands to control the volume of any white noise produced by the speaker 16, control the pitch, bass, or treble of the white noise produced by the speaker 16, provide an answer or response to a hearing test question, prompt a menu for selecting one or more pieces of music, sound, or other pieces of media, or control one or more other functions of the wireless earpiece 10. Menu selections may be made with a subsequent sound or voice command or with haptics using a touch or gesture interface.

In another embodiment, the user interface 18 may allow a user to select a different color of noise (e.g., pink, red, grey, blue, brown, white, black, etc.), such as pink noise. Pink noise is a signal or process with a frequency spectrum so the power spectral density (energy or power per frequency interval) is inversely proportional to the frequency of the signal. For example, in pink noise, each octave (halving/doubling in frequency) carries an equal amount of noise energy. The name arises from the pink appearance of visible light with this power spectrum. Pink noise is in contrast with white noise which has equal intensity per frequency interval. In one embodiment, the user may be able to specify the signal intensity per frequency or may utilize any number of thresholds specified by the user or a medical professional.

If the user interface 18 is a touch interface, the user or a third party may use haptics to prompt a menu for controlling the volume, pitch, bass, or treble of the white noise or other sound, select a hearing test, make a selection in response to a query posed by the hearing test, make a selection of a sound, music, or piece of media to play, or control one or more other functions of the wireless earpiece 10. The touch interface may have one or more visible areas in which to touch to bring up a prompt. The visible areas may be illuminated using one or more LEDS operatively connected to the processor 14. A gesture interface may be used in a manner like the touch interface.

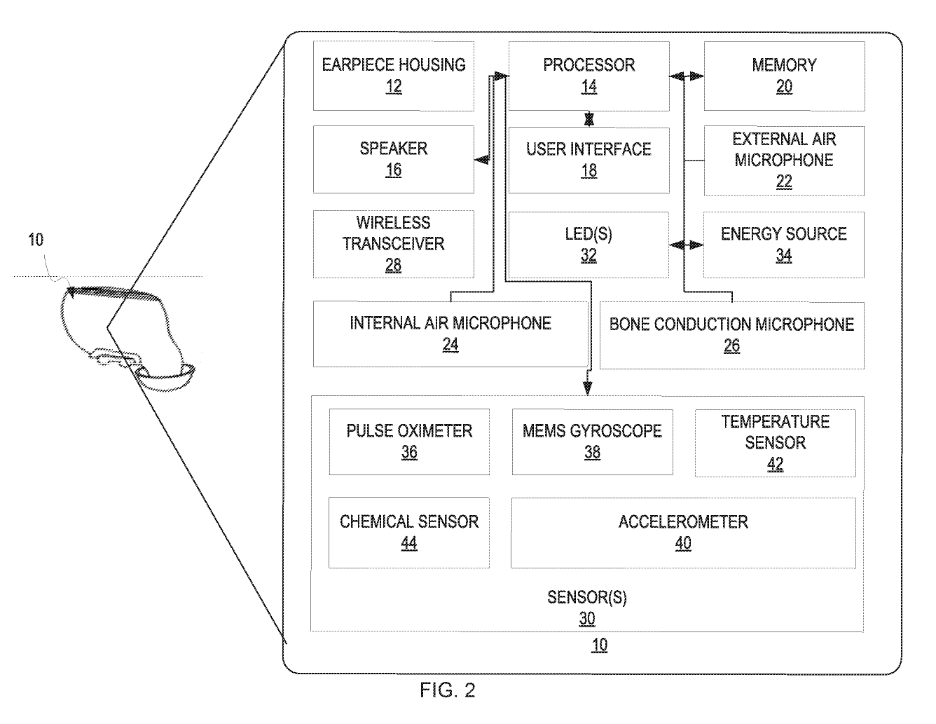

FIG. 2 illustrates another embodiment of the wireless earpiece 10 in accordance with an illustrative embodiment. In addition to the earpiece housing 12, the processor 14, the speaker 16, and the user interface 18 referenced above, the wireless earpiece 10 may include one or more memories 20, an external air microphone 22, an internal air microphone 24, a bone conduction microphone 26, a wireless transceiver 28, one or more sensors 30, one or more light emitting diodes (LEDs) 32, and an energy source 34. Each of the components may be operatively connected to the processor 14 or another component of the wireless earpiece 10 utilizing busses, wires, traces, pins, connectors, interfaces, or so forth.

One or more memories 20 may be operatively connected to the processor 14. The memories 20 may be any type of non-volatile memory, which may be static and/or dynamic, for allowing data storage when the wireless earpiece 10 is not powered. In some embodiments, additional volatile memories, such as random-access memories may be incorporated into the memories 20 to allow for improved functionality. The memories 20 may be configured and/or programmed to store kernels, applications, programs, instructions and/or data for either concurrent or future use by the processor 14 or another component of the wireless earpiece 10 and in some embodiments the memories 20 may be integrated with the processor 14 for improved functionality. The memories 20 may store one or more hearing tests, one or more different types of signals encoding white noise, one or more types of sounds, songs, fitness programs, health monitoring programs, hearing test results, sensor readings, signals encoding information received from a third-party electronic device, or other types of data or information possibly of interest to the user.

The external air microphone 22 may be operatively connected to the processor 14 and may be used to provide voice commands to the wireless earpiece 10 or receive ambient sounds which may be stored on the memory 20 by the processor 14 for use in calibrating or modifying a white noise signal. The external air microphone 22 is outwardly facing on the wireless earpiece 10 for improved reception. The external air microphone 22 may include components such as analog-to-digital converters, amplifiers, attenuators, filters, and/or other components necessary for the external air microphone 22 to convert a sound wave into an electrical signal. Voice commands received by the external air microphone 22 may be used by one or more programs or applications executed by the processor 14 for controlling one or more functions of the wireless earpiece 10. In one embodiment, sounds, speech, and noises detected by the external air microphone 22 may be utilized to automatically adjust or tune the white noise generated by the wireless earpiece 10.

As noted, ambient sounds received by the external air microphone 22 may be used by the processor 14 for calibrating or modifying white noise signals in accordance with hearing test results or information provided by the user or a third party regarding the user's hearing. For example, the processor 14 may execute an application stored on the memory 20 adjusting the volume of the white noise when the external air microphone 22 is receiving continuous background noise. For example, in loud environments, the amplitude of the white noise may be increased. Likewise, in quiet environments, the amplitude of the white noise may be decreased to protect the user and provide optimal treatments. Other sound properties, such as the bass, midrange, or treble may be adjusted as well if a colored noise is desired in lieu of white noise. Similarly, the frequencies utilized may be modified, excluded, added, or so forth.

The internal air microphone 24 may be operatively connected to the processor 14 and may be used for receiving sounds within the user's ear canal. The internal air microphone 24 may be positioned proximate to the tympanic membrane of the user for improved reception. Like the external air microphone 22, the internal air microphone 24 may include components such as analog-to-digital converters, amplifiers, attenuators, filters, and/or other components necessary for the internal air microphone 24 to convert a sound wave into an electrical signal. Sounds received by the internal air microphone 24 may be used by the processor 14 for calibrating or modifying a white noise or colored noise signal in response to or in accordance with one or more results of a hearing test, a noise mix, pattern, treatment, or so forth. For example, the processor 14 may instruct the speaker 16 to emit one or more sounds at a certain frequency in accordance with an audiometric program executed by the processor 14. The internal air microphone 24 receives sounds from the user's ear canal in response to the emitted sounds. The sounds received by the internal air microphone 24 may then be used by the audiometric program in calibrating a white noise or other colored noise signal for the user.

The bone conduction microphone 26 may be operatively connected to the processor 14 and may be used for sensing sounds within the user's ear canal. The bone conduction microphone 26 may be positioned proximate to the user's temporal bone for improved reception. Like the external air microphone 22 and the internal air microphone 24, the bone conduction microphone 26 may include components such as analog-to-digital converters, amplifiers, attenuators, filters, and/or other components necessary for the bone conduction microphone 26 to convert a sound wave into an electrical signal. The sounds received by the bone conduction microphone 26 may be used for calibrating or modifying white noise or other types of colored noise signals generated by the processor 14. For example, sounds created in response to the sound of the user's voice or a testing pulse from the speaker 16, may be received by the bone conduction microphone 26 and communicated to the processor 14, which may use the sounds/speech in calibrating or modifying the tone of the white noise, such as adding more bass to the white noise and decreasing amplitudes to create pink noise or brown noise.

The wireless transceiver 28 may be operatively connected to the processor 14 and may receive or transmit signals encoding white noise, another type of colored noise, or data related to white noise or colored noise. The wireless transceiver 28 may be a Bluetooth transceiver, a cellular transceiver (e.g., 3G, 4G, LTE, PCS, etc.), a Wi-Fi transceiver, or another type or class of wireless transceiver simultaneously receiving signals from electronic devices at substantial distances and meet one or more IEEE standards. The wireless transceiver 28 may also be a near-field magnetic induction (NFMI) transceiver for sending short range signals to another electronic device such as a wireless earpiece. The wireless transceiver 28 may be configured to receive signals from mobile devices such as smartphones, communications towers, satellites, desktops, laptops, watches, or other types of electronic devices and communicate the signals to the processor 14. The processor 14 may use the data encoded in the signals during execution of one or more programs or applications and/or store the data in the memory 20. For example, the processor 14 may instruct the wireless transceiver 28 to transmit a signal encoding white noise, pink noise, brown noise, gray noise, or another type of colored noise to a second wireless earpiece for playback. In addition, the wireless transceiver 28 may receive a signal encoding connection information from the wireless earpiece 10 or another electronic device.

One or more sensors 30 may be operatively connected to the processor 14 and may be used for calibrating white noise or another type of colored noise for playback via the speaker 16 on the wireless earpiece 10. The sensors 30 operatively connected to the processor 14 may include a pulse oximeter 36, a MEMS gyroscope 38, an electronic accelerometer 40, a temperature sensor 42, and a chemical sensor 44. Each type of sensor may be used for calibrating or modifying a white noise or colored noise response. For example, readings from the temperature sensor 42 or the chemical sensor 44 may be used by the processor 14 to adjust any readings from the bone conduction microphone 26 or another sensor 30 for calibrating a white noise or colored noise signal.

The LEDs 32 may be operatively connected to the processor 14. The LEDs 32 may be semiconductor-based light sources and may include displays, touch sensors, and/or other interactive interface components. In addition, the LEDs 32 may be configured to provide information concerning the wireless earpiece 10. For example, the processor 14 may communicate a signal encoding information related to the current time, the energy level of the wireless earpiece 10, the status of another operation of the wireless earpiece 10, or another earpiece program or function to the LEDs 32. If the signal concerns the energy level of the wireless earpiece 10, the LEDs 32 may decode the signal as a colored light. For example, a blue light may represent a full battery, a green light may represent a high level of battery life, a yellow light may represent an intermediate level of battery life, a red light may represent a limited amount of battery life, and a blinking red light may represent a critical level of battery life requiring immediate recharging. In addition, the battery life may be represented by the LEDs 32 as a percentage of battery life remaining or may be represented by an energy bar having one or more LEDs. For example, the number of illuminated LEDs represents the amount of battery life remaining in the wireless earpiece 10. The LEDs 32 may be in any area on the wireless earpiece 10 suitable for viewing by the user or a third party and may also include as few as one diode which may be provided in combination with a light guide. In addition, the LEDs 32 need not have a minimum luminescence.

The energy source 34 may be operatively connected to each of the wireless earpiece 10 components and may provide enough power to operate the wireless earpiece 10 for a reasonable duration of time. The energy source 34 may be of any type suitable for powering the wireless earpiece 10, such as a lithium ion battery. In one embodiment, the wireless earpiece 10 may be powered by a fuel cell, solar cell, ultra-capacitor, piezo electric generator, thermal generator, or so forth. Alternative battery-less power sources, such as sensors configured to receive energy from radio waves or other types of electromagnetic radiation, may be used to power the wireless earpiece 10 in lieu of the energy source 34. In one embodiment, the processor 14 may shut down components or features of the wireless earpieces 10 to preserve the battery life. For example, the wireless earpieces 10 may shut down the transceivers and sensors 30 to extend the battery life and white noise generation capabilities.

In one embodiment, the wireless earpiece 10 may not include some of the components shown in the illustrative embodiment. For example, the wireless earpiece 10 may not include any transceivers, instead each wireless earpiece 10 may independently generate a white noise or colored noise signal. Likewise, the earpiece 10 may not include the microphones 22, 24, 26, sensors 30. The earpiece 10 may also not include more advanced user interfaces. The earpiece 10 may also utilize dedicated logic instead of a processor 14 to generate the colored noise for playback at the speaker 16. As a result, the energy source 34 of the earpiece 10 may be preserved for extended treatment of the user. One or more buttons, dials, touch sensors, or controls may control the type of white noise or colored noise generated and the associated volume. The earpiece 10 may be utilized in only one ear or both ears as necessitated by the user's condition. As a result, the earpiece 10 may independently manage the white noise communicated to the user to treat tinnitus or other similar conditions. In some embodiments, instrumental, classical, or other types of music may also be utilized as a colored noise option to treat or entertain the user. The user may adjust the earpiece 10 to perform customized tinnitus masking

In some embodiments, the wireless earpieces 10 may be prescribed, leased, or otherwise distributed for treating users with any number of conditions or needs. For example, an Ear Nose Throat (ENT) doctor may prescribe the wireless earpiece 10/earpiece for utilization by a patient.

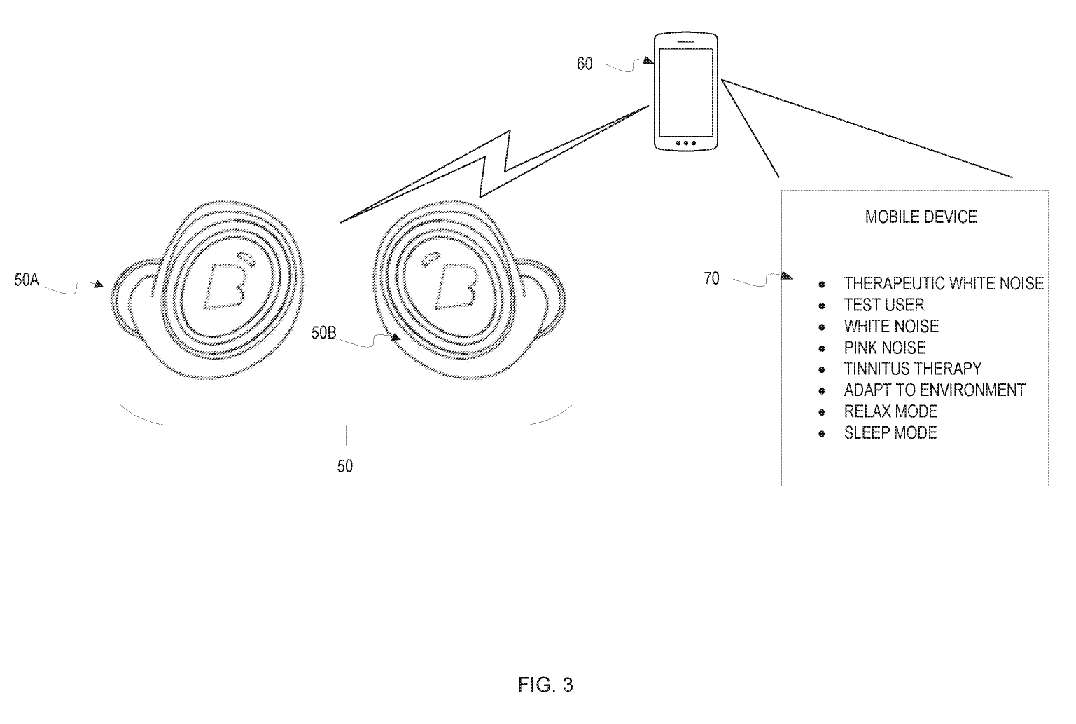

FIG. 3 illustrates a mobile device 60 in operative communication with a set of wireless earpieces 50 in accordance with an illustrative embodiment. Wireless earpiece 10 may be a part of the set of wireless earpieces 50, which may include a left wireless earpiece 50A and a right wireless earpiece 50B. The mobile device 60 may be a smartphone, a cell phone, a tablet, a laptop, a gaming device, a music player, an e-book, a smartwatch, a pair of smart glasses, or any type of mobile device having a display and a user interface. The user interface may be partially or completely integrated with the display. The mobile device 60 may have a transceiver which may be used to communicate with the set of wireless earpieces 50. An application 70 may be used via the user interface on the mobile device 60 for controlling the wireless earpiece 50A, 50B or the set of wireless earpieces 50. For example, the user may use the app 70 to instruct each speaker of the set of earpieces 50 to produce white noise. The user may also instruct each speaker to produce another type of colored noise, a piece of media, a health monitoring program, a fitness program, or another type of program desired by the user.

In addition, the user may use the application 70 to calibrate or modify the white noise to create a specific type of colored noise desired by the user. For example, the user may use the application 70 to adjust the volume of the white noise or adjust a slider corresponding to a frequency or decibel level, such as increasing a treble slider to create blue or violet noise. Results from hearing tests may also be used by the application 70 for calibrating or modifying a white noise or colored noise sound. The hearing test results may be the results from tests using the set of wireless earpieces 50 or a hearing test administered by a medical professional such as an otolaryngologist or an audiologist.

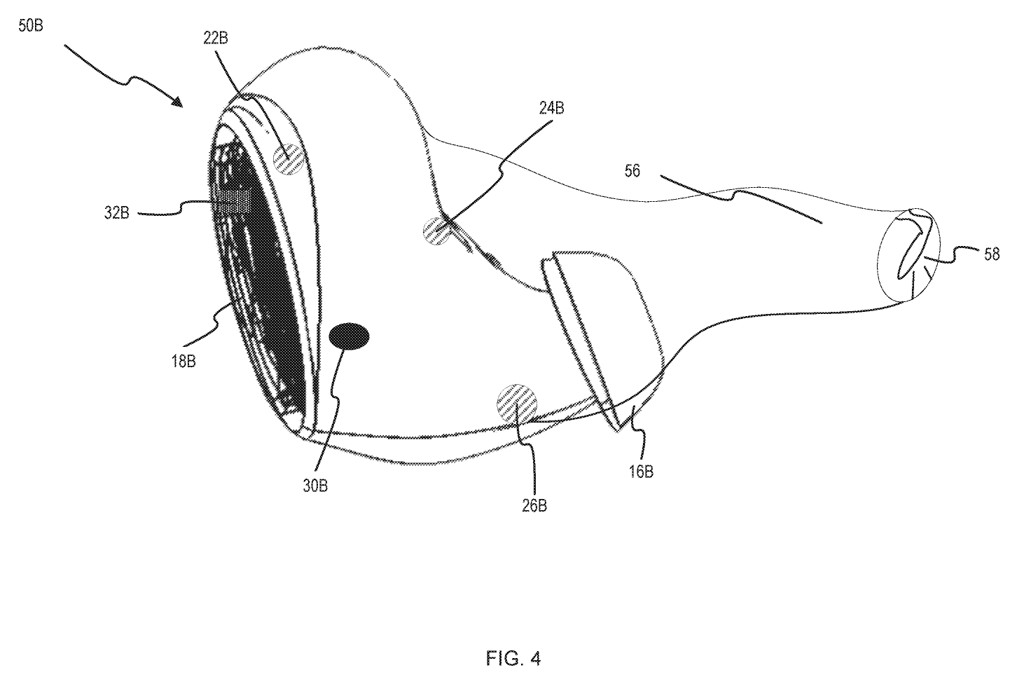

FIG. 4 illustrates a side view of the right wireless earpiece 50B and its relationship to the user's ear in accordance with an illustrative embodiment. The following description may also apply to the wireless earpiece 10. The right wireless earpiece 50B may be configured to both minimize the amount of external sound reaching a user's external auditory canal 56 and to facilitate the transmission of sound from speaker 16B to a user's tympanic membrane 58. The right wireless earpiece 50B may also be configured to be of any size necessary to comfortably fit within the user's external auditory canal 56.

A user interface 18B may be positioned on the outside of the right wireless earpiece 50B and may provide for touch or gestural control by the user or a third party, such as by tapping or swiping across the user interface 18B, tapping or swiping across another portion of the right earpiece 50B, providing a gesture not involving the touching of the user interface 18B or another part of the right earpiece 50B, or through the use of an instrument configured to interact with the user interface 18B. The user may use the user interface 18B to pair or connect one or more electronic devices which may be in the possession of the user or one or more third parties. The user interface 18B may include a touch sensor, a touch screen, an infrared sensor, or one or more sensors for receiving user input and interacting with the user.

LEDs 32B may also be present, which may be integrated with the user interface 18B. An external air microphone 22B may be positioned on the outside of the right wireless earpiece 50B to sense voice commands or ambient sound. In addition, an internal air microphone 24B may be positioned proximate to the user's tympanic membrane 58 for sensing sounds with the user's external auditory canal 56. The LEDs 32B may deliver information regarding battery status, charging status, user interactions, programs in process, user information, and so forth.

Furthermore, a bone conduction microphone 26B may be positioned near the temporal bone of the user's skull to receive sounds and vibrations directly from the bone. The bone conduction microphone 26B may also sense sounds before the sounds reach either the external air microphone 22B or the internal air microphone 24B to differentiate between sounds from the user and ambient sounds.

Sensor 30B may be positioned on an area of the right wireless earpiece 50B within the external auditory canal 56 and may be used to sense temperature, air pressure, chemical composition, or another physical parameter possibly used in producing, calibrating or modifying white or colored noise.

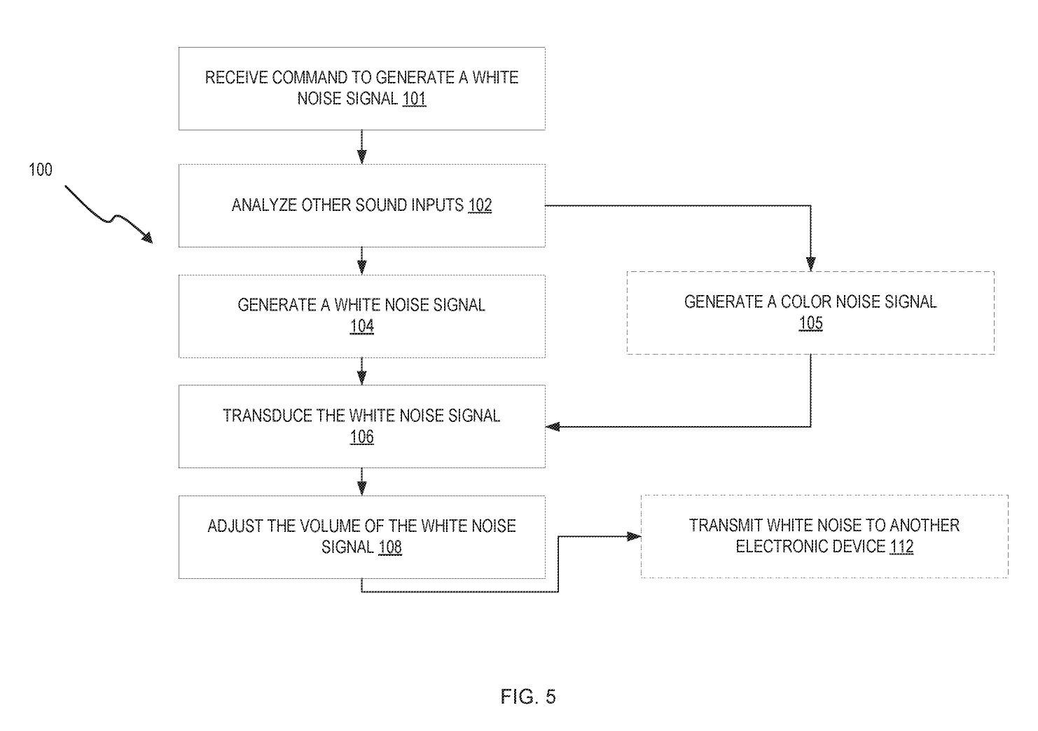

FIG. 5 illustrates a flowchart of a method 100 of providing white noise using a wireless earpiece in accordance with an illustrative embodiment. In one embodiment, at step 101 the signal encoding the white noise may be generated in response to a voice command from the user or a third party via a microphone 24, 26, a touch command from the user or a third party via a user interface 16, a gestural command sensed by a sensor 30 from the user or a third party, a command from a hearing test executed by the processor 14, a command in accordance with one or more results relating to a hearing test executed by the processor 14, a command issued using a mobile device 60, or a command issued from another third party electronic device. The process of step 101 may also be implemented based on a manual process (e.g., voice command, finger tap, soft button selection by a user, activation of a program/interface, etc.).

At step 102, the processor 14 may use data or information received from an air microphone 24, a bone conduction microphone 26, and/or one or more sensors 30 to calibrate the white noise. The processor 14 may also execute one or more kernels while executing the application 100.

In step 104, a signal encoding the white noise is generated. In one embodiment, the white noise is generated utilizing the processor 14 (e.g., digital logic, hardware, processor, etc.) of the wireless earpiece 50B. The process of step 104 may be implemented automatically based on the logic of the processor 14 of the wireless earpieces 50. The process may also be initiated in response to a command from a smart phone 60 or other electronic device associated with the wireless earpieces 50 set out in step 101. The white noise may be generated in any number of formats, files, streams, packets, or so forth played by the wireless earpieces or other associated devices. The white noise may also be received by wireless transceiver 28, sent to processor 14 for volume control and or signal conditioning and then routed to speaker 16.

Next, in step 106, the signal encoding the white noise is transduced by the speaker. The signal may be transduced at a volume set by the user, at a volume set by a third party, at an automatically determined treatment volume, amplitude, or frequency, or at a volume set using a mobile device such as a smartphone at step 108. The sound may be transduced proximate to the user's tympanic membrane or may be transduced via the temporal bone of the user's skull for users who have difficulty hearing. For example, the speaker may also utilize bone conduction or vibrations to interact with the user.

As another example in step 112, the processor 14 may execute a program for transmitting a signal encoding the white noise to another electronic device, such as a second wireless earpiece 50A using a wireless transceiver 28. The signal may encode additional data or information such as the volume, bass, treble, frequency, pattern (if any) or other sound properties of the white noise. Furthermore, the signal may encode other information such as the date and time of transmission, the identity of the user being treated with white noise, a connection frequency or waveform, the device which generated the signal encoding the white noise, or other information which may be of relevance to someone using another electronic device to listen to the white noise. In one example, the signals may be transmitted utilizing Wi-Fi, Bluetooth, NFMI, HD wireless, or other similar wireless standards, protocols, or signals.

In another embodiment shown in step 5, the processor 14 may allow a user to select a different color of noise (e.g., pink, red, grey, blue, brown, white, black, etc.), such as pink noise. Pink noise is a signal or process with a frequency spectrum so the power spectral density (energy or power per frequency interval) is inversely proportional to the frequency of the signal. For example, in pink noise, each octave (halving/doubling in frequency) carries an equal amount of noise energy. The name arises from the pink appearance of visible light with this power spectrum. Pink noise is in contrast with white noise which has equal intensity per frequency interval. In one embodiment, the user may be able to specify the signal intensity per frequency or may utilize any number of thresholds specified by the user or a medical professional.

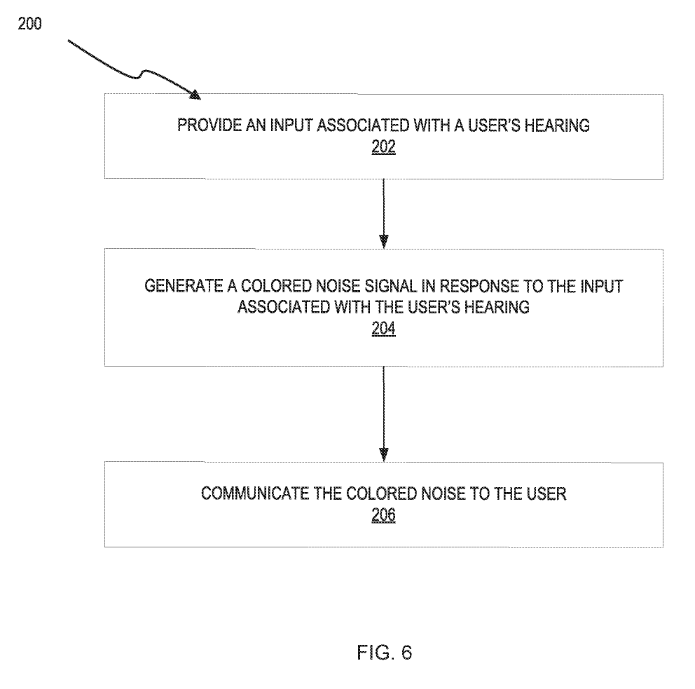

FIG. 6 illustrates a flowchart of a method 200 of providing colored noise using a wireless earpiece in accordance with an illustrative embodiment. First, in step 202, an input associated with a user's hearing is provided. For example, the input may be 1) a voice command from the user to listen to white noise, 2) a haptic command from the user or a third party to listen to a colored noise, such as pink noise or gray noise, 3) a command from the user issued on an external electronic device, such as a smartphone to listen to white noise or another colored noise, such as pink noise or gray noise, 4) a result from a hearing test provided by the wireless earpiece or a medical professional, or 5) information derived from a hearing test. The foregoing list is non-exclusive. If the hearing test was administered by a medical professional, the results of the hearing test may be stored in a memory of the wireless earpiece or may be provided in response to a command issued on a mobile device.

Second, in step 204, a colored noise signal is generated in response to the input associated with the user's hearing. The colored noise signal may include white noise, pink noise, brown noise, gray noise, blue noise, violet noise, or another type of colored noise. If the input is a result of information derived from a hearing test, the colored noise signal may be calibrated to simulate a white noise signal. For example, if a hearing test determines the user has difficulty hearing higher frequency sounds, a bluish sound may be generated to compensate for the user's inability to perceive the colored noise signal as white noise. In addition, if the user has certain hearing defects, such as sensorineural or conductive hearing loss, a colored sound signal may be specifically calibrated considering the hearing defects or disabilities.

Third, in step 206, the colored noise signal is communicated to the user. The colored noise signal may be communicated or transduced with characteristics set by the user or a third party (e.g., volume, frequency, duration, etc.). The sound may be communicated proximate to the user's tympanic membrane or may be communicated via the temporal bone of the user's skull for users who have difficulty hearing.

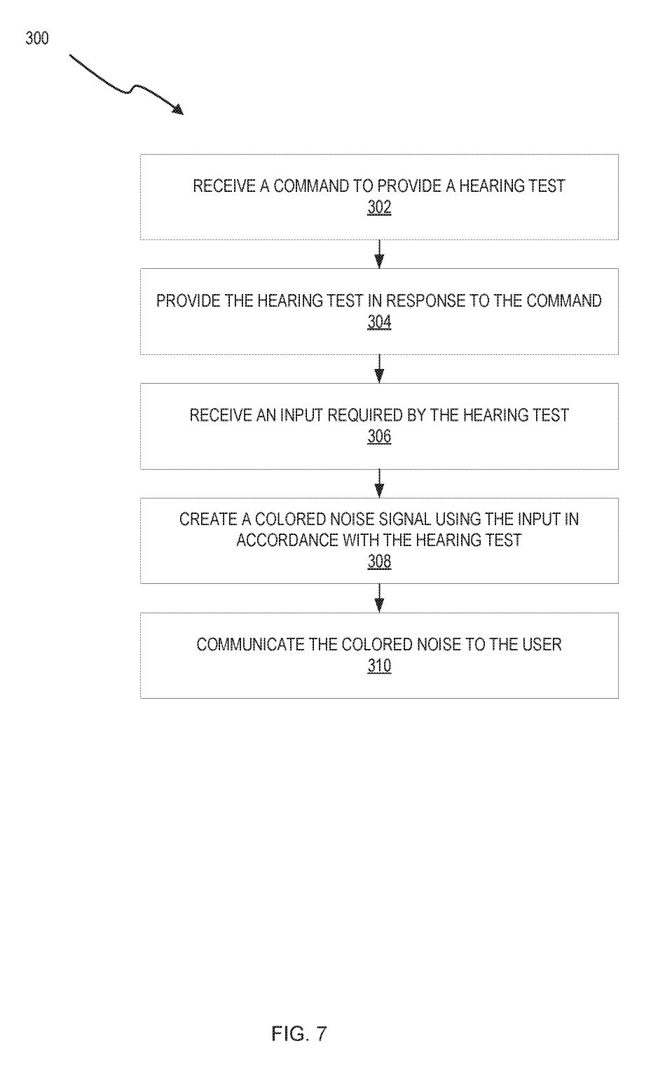

FIG. 7 illustrates a flowchart of a method 300 of providing a colored noise signal in response to a hearing test using a wireless earpiece. First, in step 302, a command is received from the user or a third party to provide the hearing test. The command may be a voice command received at a microphone, a haptic command received at a touch interface, a command sensed by a gesture interface, a command from the user or a third party encoded in a signal received from a mobile device, or a command encoded in another signal received from another external electronic device.

Next, in step 304, the hearing test is provided via a speaker in response to the command. The hearing test may be an objective hearing test, such as an otoacoustic emissions test, a stapedius reflex test, a tympanometric test, or a subjective hearing test, such as a pure-tone audiometry test or a speech test. The hearing test may require an inwardly facing microphone such as an internal air microphone or a bone conduction microphone to sense sounds emanating from the user's ear. For example, if the user selects an otoacoustic emissions test using a voice command sensed by an external air microphone or a gestural command sensed by a user interface to test their inner ear hearing capacity, the internal air microphone and/or the bone conduction microphone can receive sounds within the user's external auditory canal. The sounds, however, may or may not be in response to sounds produced by the speaker in accordance with the hearing test depending on the type of otoacoustic emission test (spontaneous or evoked). If the sounds received by the internal air microphone and/or the bone conduction microphone are below normal, this information may be used by a program executed by the processor to produce a bluish sound in lieu of a white noise sound to compensate for the fact the user has difficulty hearing higher frequency sounds. The sounds received by the internal air conduction microphone and the bone conduction microphone may be stored in a memory for later use or reference.

Next, in step 306, an input is received from the user in accordance with a requirement of the hearing test. The input may represent any number of reactions, input, or feedback, including, but not limited to, a verbal response to a question from a pure tone audiometry test, a touch, motion, or gesture sensed by the sensors of user or gesture interface to answer a hearing question, a sound emanating from the user's ear used to determine the user's hearing response, a sound generated by the user's ear in response to a sound or other stimulus produced at the speaker to determine the user's hearing response, or a stimulus generated by the user, with or without the user's knowledge, in response to a sound or stimulus to determine the user's hearing response. In another example, if the user selects a pure tone audiometry test, the speaker may produce sounds of varying intensity and tone. The user may signify the user heard each sound using a voice command received at an external air microphone, a sound received at the external air microphone, a touch across a user interface, a gesture sensed by the user interface, or another type of gesture capable of being sensed by the wireless earpiece. The input may be received contemporaneous with the requirement or may be provided at a time after the requirement is known or needed. In addition, more than one input may be required.

Next, in step 308, a colored noise signal is created using the input provided by the user in accordance with the hearing test. The colored noise signal may be created so if the user has difficulty hearing low frequency sound, the bass of the colored noise signal is played at a higher volume than the treble to create a pink noise signal perceived by the user as white noise. In addition, if the user has difficulty hearing certain ranges of frequencies, the colored signal may be modified to enhance the volume at the intervals the user has difficulty hearing to create a unique colored noise signal perceived by the user as white noise when communicated via the speaker of the wireless earpiece.

Next, in step 310, the colored noise signal is communicated to the user. For example, the colored noise signal may be transduced via the speaker of the wireless earpiece to the user's tympanic membrane. The speaker may be positioned proximate to the user's tympanic membrane to enhance effectiveness. The user may adjust the volume using a voice command or a touch or gesture sensed by either the user interface or another sensor.

The invention is not to be limited to the embodiments described herein. The invention contemplates numerous variations. The foregoing description has been presented for purposes of illustration and description. It is not intended to be an exhaustive list or limit any of the invention to the precise forms disclosed. It is contemplated other alternatives or exemplary aspects are considered included in the invention. The description is merely examples of embodiments, processes or methods of the invention. It is understood any other modifications, substitutions, and/or additions can be made, which are within the intended spirit and scope of the invention.

What is claimed is:

1. A wireless earpiece comprising:
an earpiece housing;
a processor disposed within the earpiece housing, wherein the processor is configured to generate white noise;
a speaker for transducing the white noise operatively connected to the processor; and
a user interface for operatively selecting the white noise operatively connected to the processor;
wherein the wireless earpiece is configured to communicate the white noise at the speaker at a volume level set by a user through the user interface.

2. The wireless earpiece of claim 1, further comprising a wireless transceiver disposed within the housing and operatively connected to the processor, wherein the wireless transceiver communicates the white noise to a second earpiece associated with the wireless earpiece.

3. The wireless earpiece of claim 1, further comprising a memory operatively connected to the processor, wherein a hearing test is stored in the memory.

4. The wireless earpiece of claim 1, wherein the user interface provides for voice control, haptic control, and/or gesture control.

5. The wireless earpiece of claim 1, wherein the volume level and frequencies of the white noise are determined by user preferences.

6. The wireless earpiece of claim 3, wherein the hearing test stored on the memory is selectable using the user interface.

7. The wireless earpiece of claim 3, wherein the speaker communicates a test pulse in accordance with the hearing test.

8. A method for providing white noise using a wireless earpiece, the method comprising:
receiving a command to generate a white noise signal at a user interface located on the wireless earpiece;
generating a white noise for a user, wherein a processor operably connected to the user interface and disposed within the wireless earpiece generates the white noise; and
communicating the white noise to the user utilizing a speaker operatively connected to the processor of the wireless earpiece.

9. The method of claim 8, further comprising transmitting, via a wireless transceiver operatively connected to the processor, a signal associated with the white noise to a second wireless earpiece associated with the wireless earpiece

10. The method of claim 9, wherein the white noise can include variations of white noise such as pink noise and purple noise.

11. The method of claim 9, further comprising:
performing a hearing test in response to a request from a user for automatically selecting the white noise based on results of the hearing test.

12. The method of claim 11, further comprising:
receiving sound at a bone conduction microphone positioned proximate to a tympanic membrane within an ear canal of the user, wherein the white noise is generated in response to the sound received by the bone conduction microphone.

13. The method of claim 12, wherein the white noise in encoded within a signal, and wherein the volume and the frequency of the white noise is generated in response to the results provided by the user in response to the hearing test.

14. The method of claim 13, wherein the white noise is a treatment for tinnitus of the user.

15. A system for generating white noise, comprising:
a set of wireless earpieces, comprising:
an earpiece housing;
a processor disposed within the earpiece housing, wherein the processor is configured to generate white noise;
a speaker for transducing the white noise operatively connected to the processor;
a transceiver for sending and receiving communications; and
a user interface for operatively selecting the white noise operatively connected to the processor;
a mobile device, comprising:
a transceiver for sending and receiving communications;
an application for controlling the set of wireless earpieces;
wherein the application of the mobile device can instruct the processor of the set of wireless earpieces to generate white noise for transducing the white noise to a user at the speaker.

16. The system of claim 15, wherein the processor can be instructed to perform a hearing test with the user to automatically determine the white noise appropriate for the user.

17. The system of claim 16, wherein the white noise can be most any form of spectral noise including pink, gray and blue noise.

18. The system of claim 17, wherein the user can set the volume of the white noise from the mobile device.

19. The system of claim 18, wherein the earpiece communicates the white noise in an ear canal of the user.

20. The system of claim 7, further comprising an internal air microphone operatively connected to the processor and positioned proximate to a tympanic membrane of the user, and wherein the internal air microphone is configured to receive an ear canal sound in response to the test pulse communicated by the speaker.
